(19) United States
(12) Patent Application Publication
(10) Pub. No.: US 2009/0172125 A1
(43) Pub. Date: Jul. 2, 2009

(54) METHOD AND SYSTEM FOR MIGRATING A COMPUTER ENVIRONMENT ACROSS BLADE SERVERS

(76) Inventors: Mrigank Shekhar, Camas, WA (US); Vincent J. Zimmer, Federal Way, WA (US); Palsamy Sakthikumar, Puyallup, WA (US); Rob Nance, Austin, TX (US)

Correspondence Address: Barnes & Thornburg, LLP, c/o CPA Global, P.O. Box 52050, Minneapolis, MN, 55402, US

(21) Appl. No.: 11/966,136

(22) Filed: Dec. 28, 2007

(51) Int. Cl. G06F 15/167

(52) U.S. Cl. 709/215; 709/213

(57) ABSTRACT

A method and system for migrating a computer environment, such as a virtual machine, from a first blade server to a second blade server includes storing data generated by the first and second blade servers on a shared hard drive and transferring a logic unit number from the first blade server to the second blade server. The logic unit number identifies a location of the shared hard drive used by the first blade server to store data. Additionally, the state of the central processing unit of the first blade server may be transferred to the second blade server.

### BACKGROUND

Blade servers are self-contained computer servers configured for high-density computing environments. Blade servers are housed in blade enclosures, which may be configured to hold a plurality of blade servers. The plurality of blade servers and the blade enclosure form a blade server system. In a typical blade server system, each of the blade servers include individual processors, memory, chipsets, and data storage. For example, each blade server may include one or more hard drives. During operation, each blade server stores data related to the operation of the particular blade server on its associated hard drive. As such, if a failure of one or more of the blade servers occurs, migration of the computer environment of the blade server experiencing the failure requires data transfer of all the data stored on the associated hard drive to a hard drive of a replacement blade server. Such data transfer involves large amounts of data and bandwidth resulting in long data migration periods.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of one embodiment of a blade server system;

FIG. 2 is a perspective view of one embodiment of a blade server rack of the blade server system of FIG. 1;

FIG. 3 is an elevation view of one embodiment of a blade server configured to be coupled with the blade server rack of FIG. 2;

FIG. 4 is a simplified flowchart of one embodiment of an algorithm for migrating a computer environment across blade servers.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

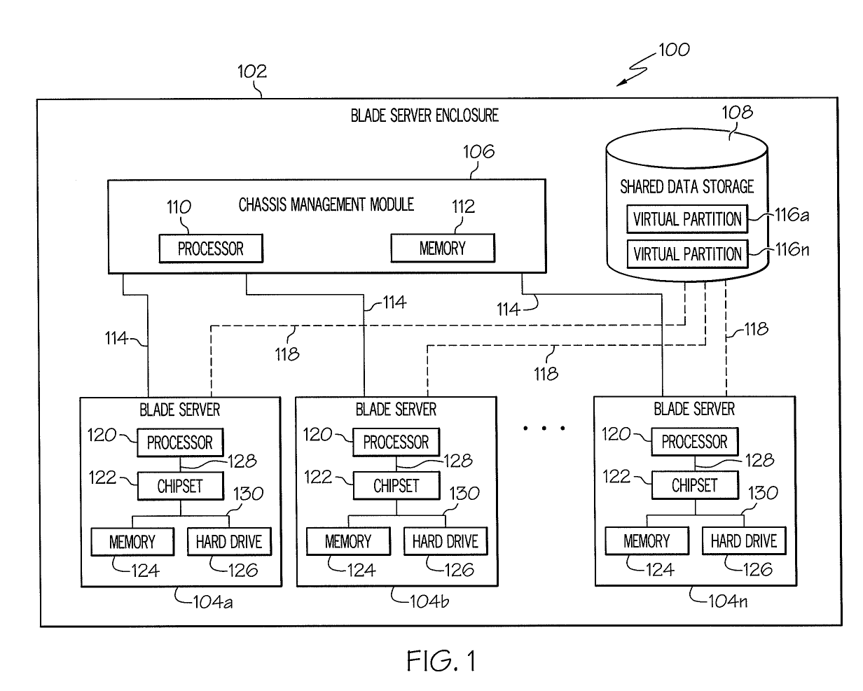

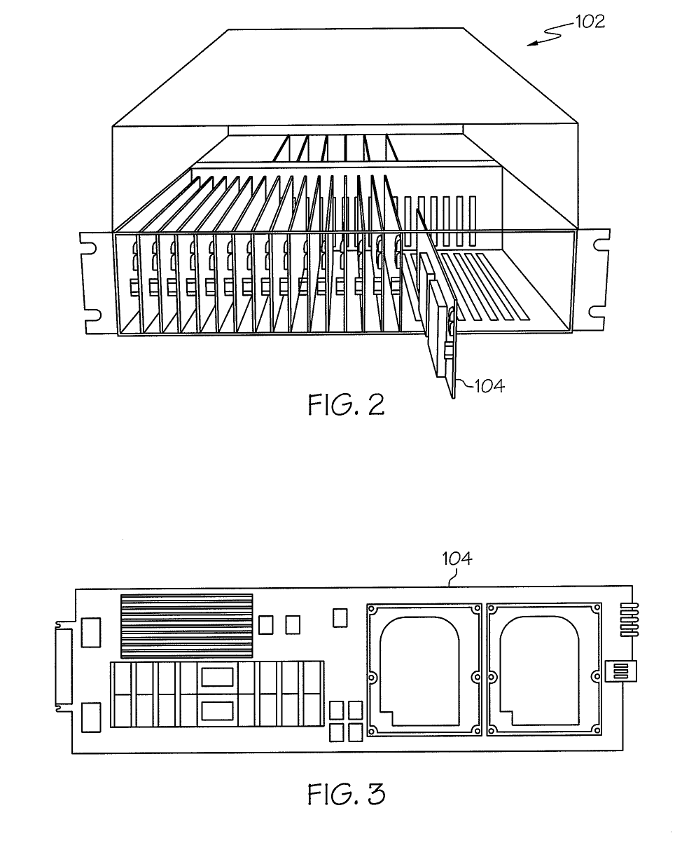

Referring now to FIG. 1, a blade server system 100 includes a blade server enclosure 102 and a plurality of blade servers 104a-104n housed in the blade server enclosure 102. The blade server enclosure 102 may be configured to support various numbers of blade servers 104. For example, the blade server enclosure 102 may be configured to house twenty, forty, one hundred, or more blade servers 104. To do so, the blade server enclosure 102 may include structural components such as guide rails or the like (not shown) to provide a slot or port for securing each of the blade servers 104 to the enclosure 102. One embodiment of a blade server housing 102 is illustrated in FIG. 2. Additionally, one embodiment of a blade server 104 is illustrated in FIG. 3.

The blade server system 100 also includes a chassis management module (CMM) 106 and a shared data storage device 108 such as a hard drive. In the illustrative embodiment of FIG. 1, the chassis management module 106 and the storage device 108 are housed in the blade server enclosure 102. However, in other embodiments, the chassis management module 106 and the storage device 108 may be external or otherwise remote relative to the blade server enclosure 102. For example, the storage device 108 may be embodied as a remote hard drive, the chassis management module 106 and the storage device 108 may be external.

In the illustrative embodiment, the chassis management module 106 includes a processor 110 and a memory device 112. The processor 110 illustratively includes a single processor core (not shown). However, in other embodiments, the processor 110 may be embodied as a multi-core processor having any number of processor cores. Additionally, chassis management module 106 may include additional processors having one or more processor cores in other embodiments. The memory device 112 may be embodied as dynamic random access memory devices (DRAM), synchronous dynamic random access memory devices (SDRAM), double-data rate dynamic random access memory device (DDR SDRAM), and/or other volatile memory devices. Additionally, although only a single memory device is illustrated in FIG. 1, in other embodiments, the chassis management module 106 may include additional memory devices. Further, it should be appreciated that the chassis management module 106 may include other components, sub-components, and devices not illustrated in FIG. 1 for clarity of the description. For example, it should be appreciated that the chassis management module 106 may include a chipset, input/output ports and interfaces, network controllers, and/or other components.

The chassis manger module 106 is communicatively coupled to each of the blade servers 104 via a plurality of signal paths 114. The signal paths 114 may be embodied as any type of signal paths capable of facilitating communication between the chassis management module 106 and the individual blade servers 104. For example, the signal paths 114 may be embodied as any number of interfaces, buses, wires, printed circuit board traces, via, bus, intervening devices, and/or the like.

As discussed above, the shared data storage may be embodied as any type of storage device capable of storing data from each of the blade servers 104. For example, in the embodiment illustrated in FIG. 1, the shared data storage device 108 is embodied as a hard drive having a plurality of virtual partition 116a-116n. Each of the blade servers 104 is associated with one of the virtual partition 116 and configured to store data within the associated virtual partition 116 during operation as discussed in more detail below. The shared data storage 108 is communicatively coupled to each of the blade servers 104 via a plurality of signal paths 118. Similar to signal paths 114, the signal paths 118 may be embodied as any type of signal paths capable of facilitating communication between the shared data storage 108 and the individual blade servers 104. For example, the signal paths 118 may be embodied as any number of interfaces, buses, wires, printed circuit board traces, via, bus, intervening devices, and/or the like.

Each of the blade servers 114 includes a processor 120, a chipset 122, and a memory device 124. The processor 114 illustratively includes a single processor core (not shown). However, in other embodiments, the processor 120 may be embodied as a multi-core processor having any number of processor cores. Additionally, each blade server 104 may include additional processors having one or more processor cores in other embodiments. The processor 114 is communicatively coupled to the chipset 122 via a plurality of signal paths 128. The signal paths 128 may be embodied as any type of signal paths capable of facilitating communication between the processor 114 and the chipset 122 such as any number of interfaces, buses, wires, printed circuit board traces, via, bus, intervening devices, and/or the like.

The memory device 122 may be embodied as dynamic random access memory devices (DRAM), synchronous dynamic random access memory devices (SDRAM), double-data rate dynamic random access memory device (DDR SDRAM), and/or other volatile memory devices. Additionally, although only a single memory device is illustrated in FIG. 1, in other embodiments, each blade server 104 may include additional memory devices. The memory 124 is communicatively coupled to the chipset 122 via a plurality of signal paths 130. Similar to the signal paths 128, the signal paths 130 may be embodied as any type of signal paths capable of facilitating communication between the chipset 122 and the memory 124 such as any number of interfaces, buses, wires, printed circuit board traces, via, bus, intervening devices, and/or the like.

The blade servers 104 may also include other devices such as various peripheral devices. For example, as illustrated in FIG. 1, each of the blade servers 104 may include an individual hard drive 126 or other peripheral device. Additionally, it should be appreciated that each blade server 104 may include other components, sub-components, and devices not illustrated in FIG. 1 for clarity of the description. For example, it should be appreciated that the chipset 122 of each blade server 104 may include a memory controller hub (MCH) or northbridge, an input/output controller hub (ICH) or southbridge 114, and/or other devices.

In use, each of the blade servers 104 is configured to store data on the shared date storage device 108 in the associated virtual partition 116. If a migration event occurs, such as a failure of one of the blade servers 104, the chassis management module migrates the computing environment, such as a virtual machine, of the failing blade server 104 to a new blade server 104. Because each of the blade servers 104 use a shared storage space (e.g., a shared hard drive), the computing environment of the failing blade server 104 may be migrated without the need to transfer the large amount of data storage on the shared data storage device 108. Rather, the logical unit number (LUN) associated with the virtual partition 116 used by the failing blade server 104 may be transferred to the new, replacement blade server 104. Additionally, the state of the processor 120 of the failing blade server 104 may be transferred to the replacement blade server 104.

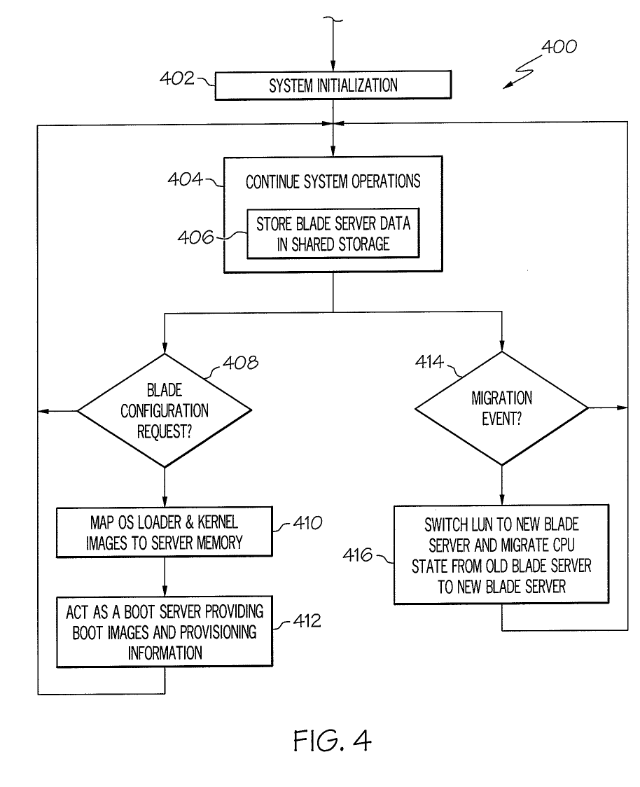

Referring now to FIG. 4, an algorithm 400 for migrating a computing environment, such as a virtual machine, across blade servers includes a block 402 in which system initialization is performed. For example, the chassis management module 106 and each of the blade servers 104 are initialized in block 402. In block 404, the blade server system 100 continues normal operation. That is, each of the blade servers 104 continues normal operation, which may, for example, include processing data, storing data, and establishing one or more virtual machines. During operation, each of the blade servers 104 is configured to store relevant data in the shared data storage device 108 (e.g., a hard drive) as indicated in block 406. One or more of the virtual partition 116 may be assigned to one of the blade servers 104 and/or one or more virtual machines established on one of the blade servers 104. As discussed above, the location of the associated virtual partition 116 on the shared data storage device 108 is identified by a logical unit number (LUN). As such, each blade server 104 and/or each virtual machine established on each blade server 104 may be configured to store relevant data in an associated virtual partition 116 of the data storage device 108 based on an assigned logical unit number, which identifies the associated virtual partition, rather than or in addition to storing the relevant data on the individual hard drive 126 of the blade server 104.

In block 408, the chassis management module 106 of the blade server system 100 monitors for a blade configuration request. A blade configuration request may be generated when a new blade server 104 is coupled to the blade server system 100 or is otherwise rebooted or initialized. If a blade configuration request is received, an operating system loader and kernel images are mapped to the memory 124 of the blade server 104. In block 412, the chassis management module 106 acts as a boot server to the new blade server 104 and provides boot images and provisioning information to the requesting blade server 104.

In addition to monitoring for blade configuration requests, the chassis management module 106 monitors for a migration event in block 414. It should be appreciated that the chassis management module 106 may monitor for blade configuration requests and migration events in a contemporaneous, near contemporaneous, or sequential manner. That is, blocks 408 and 414 may be executed by the chassis management module 106 or other component of the blade server system 100 contemporaneously with each other or sequentially in a predefined order.

The migration event may be embodied as any one of a number of events that prompt the migration of a computing environment such as a virtual machine from one blade server 104 to another blade server 104. For example, in some embodiments, the migration event may be defined by failure of a blade server 104 or devices/components of the blade server 104. Additionally or alternatively, the migration event may be based on load balancing or optimization considerations. For example, the chassis management module 106 may be configured to monitor the load of each blade server 104 and migrate virtual machines or other computing environments from those blade servers 104 having excessive loads to other blade servers 104 having loads of lesser value such that the total load is balanced or otherwise optimized across the plurality of blade servers 104. Additionally or alternatively, the migration event may be based on a predicted failure. For example, the chassis management module 106 may be configured to monitor the power consumption, temperature, or other attribute of each blade server 104. The chassis management module 106 may further be configured to determine the occurrence of a migration event when the power consumption, temperature, or other attribute of a blade server 104 is above some predetermined threshold, which may be indicative of a future failure of the blade server 104. Such power consumption, temperature, and other attributes may be monitored over a period of time and averaged to avoid false positives of migration events due to transient events such as temperature spikes.

If a migration event is detected in block 414, the computing environment (e.g., one or more virtual machines) is migrated from one blade server to another blade server in block 416. For example, if the chassis management module 106 determines that a blade server 104 has failed, will likely fail, or is over loaded, the chassis management module 106 may migrate the computing environment such as one or more virtual machines from the current blade server 104 to another blade server 104, which may be a new blade server 104 or a pre-existing, but under-loaded blade server 104.

To migrate the computing environment of one blade server 104 to another blade server 104, the chassis management module 106 switches or otherwise transfers the logic unit number used by the first blade server 104, which identifies the virtual partition 116 associated with the first blade server 104, to the second blade server 104. As such, the second blade server 104 will have access all of the data used by and stored by the first blade server 104 in the associated virtual partition 116. In addition, the chassis management module 106 may transfer the state of the central processing unit or processor 120 of the first blade server 104 to the second blade server 104. For example, the chassis management module 106 may copy the data contained in the software registers of the first blade server 104 to the software registers of the second blade server 104. Further, in other embodiments, additional data or state information may be transferred from the first blade server 104 to the second blade server 104 to effect the migration of the computing environment, such as a virtual machine, from the first blade server 104 to the second blade server 104.

It should be appreciated that because the data used by the first blade server 104 is not transmitted (e.g., transmitted of an Ethernet connection), the security of the data used by the first blade server 104 may be increased. That is, the data used by the first blade server 104 is effectively transferred to the second blade server 104 via the transfer of the logic unit number rather than the transfer of the actual data. As such, the “transferred” data remains stored on the shared data storage device 108.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

What is claimed is:

1. A method comprising:
establishing a virtual machine on a first blade server;
storing data generated by the first blade server on a hard drive shared with a second blade server; and
migrating the virtual machine from the first blade server to the second blade server in response to a migration event, wherein migrating the virtual machine includes transferring a logical unit number used by the first blade server to the second blade server.

2. The method of claim 1, wherein storing data generated by the first blade server comprises storing data generated by the first blade server in a virtual partition of the hard drive, the logical unit number identifying the location of the virtual partition.

3. The method of claim 1, wherein migrating the virtual machine from the first blade server to the second blade server comprises transferring the state of a central processing unit of the first blade server to the second blade server.

4. The method of claim 3, wherein transferring the state of the central processing unit comprises storing data indicative of register values of the first blade server.

5. The method of claim 1, wherein the logic unit number identifies a location on the hard drive used by the first blade server to store data.

6. The method of claim 1, wherein the migration event comprises the failure of the first blade server.

7. The method of claim 1, wherein migrating the virtual machine from the first blade server to the second blade server in response to a migration event comprises migrating the virtual machine from the first blade server to the second blade server based on the load balance of the first blade server and the second blade server.

8. The method of claim 1, wherein migrating the virtual machine from the first blade server to the second blade server in response to a migration event comprises migrating the virtual machine from the first blade server to the second blade server based on the power consumption of the first blade server.

9. The method of claim 1, wherein migrating the virtual machine from the first blade server to the second blade server in response to a migration event comprises performing load optimization between the first blade server and the second blade server using a chassis management module.

10. The method of claim 1, wherein migrating the virtual machine from the first blade server to the second blade server in response to a migration event comprises performing power consumption optimization between the first blade server and the second blade server using a chassis management module.

11. A machine readable medium comprising a plurality of instructions, that in response to being executed, result in a computing device
establishing a virtual machine on a first blade server;
storing data generated by the first blade server on a hard drive shared with a second blade server; and
migrating the virtual machine from the first blade server to the second blade server in response to a migration event by (i) transferring a logical unit number identifying a location of the hard drive used by the first blade server to store data to the second blade server and (ii) transferring the state of a central processing unit of the first blade server to the second blade server.

12. The machine readable medium of claim 11, wherein storing data generated by the first blade server comprises storing data generated by the first blade server in a virtual partition of the hard drive, the logical unit number identifying the location of the virtual partition.

13. The machine readable medium of claim 11, wherein the migration event comprises the failure of the first blade server.

14. The machine readable medium of claim 11, wherein migrating the virtual machine from the first blade server to the second blade server in response to a migration event comprises migrating the virtual machine from the first blade server to the second blade server based on the load balance of the first blade server and the second blade server.

15. The machine readable medium of claim 11, wherein migrating the virtual machine from the first blade server to the second blade server in response to a migration event comprises migrating the virtual machine from the first blade server to the second blade server based on the power consumption of the first blade server.

16. A system comprising:
a blade enclosure;
a plurality of blade servers positioned in the blade enclosure;
a shared hard drive communicatively coupled to each of the plurality of blade servers, wherein each of the plurality of blade servers store data on the shared hard drive; and
a chassis management module positioned in the blade enclosure and communicatively coupled to each of the plurality of blade servers, the chassis management module including a processor and a memory device coupled to the processor, the memory device having a plurality of instructions stored therein, which when executed by the processor, cause the processor to migrate a virtual machine established on a first blade server of the plurality of blade servers to a second blade server of the plurality of blade servers by transferring a logical unit number identifying a location of the hard drive used by the first blade server to store data to the second blade server.

17. The system of claim 16, wherein the migrating the virtual machine from the first blade server to the second blade server comprises transferring the state of a central processing unit of the first blade server to the second blade server.

18. The system of claim 17, wherein transferring the state of the central processing unit comprises storing data indicative of register values of the first blade server.

19. The system of claim 16, wherein migrating the virtual machine from the first blade server to the second blade server in response to a migration event comprises migrating the virtual machine from the first blade server to the second blade server based on the load balance of the first blade server and the second blade server.

20. The system of claim 16, wherein migrating the virtual machine from the first blade server to the second blade server in response to a migration event comprises migrating the virtual machine from the first blade server to the second blade server based on the power consumption of the first blade server.
